(19) United States
(12) Patent Application Publication
(10) Pub. No.: US 2019/0375236 A1
(43) Pub. Date: Dec. 12, 2019

(54) CASTER STRUCTURE

(71) Applicant: NANSIN CO., LTD., Tokyo (JP)

(72) Inventor: Takahiro Yamamoto, Tokyo (JP)

(73) Assignee: NANSIN CO., LTD., Tokyo (JP)

(21) Appl. No.: 16/349,077

(22) PCT Filed: Nov. 11, 2016
(86) PCT No.: PCT/JP2016/083612

§ 371 Date: Aug. 6, 2019

(51) Int. Cl. B60B 33/00

(52) U.S. Cl. CPC B60B 33/0028; B60B 33/0039; B60B 2900/3316; B60B 33/0068; B60B 33/0057; B60B 33/0049

(57) ABSTRACT

[Problem]

Related to a caster structure in which a sign groove for indicating a tire replacement timing of a caster including a wheel braked by a brake shoe is provided.

[Solution]

A caster structure in which a mark groove is provided in a tire of a wheel of a caster in which rotation of the wheel is braked by pressing a brake shoe onto the tire, characterized in that the mark groove in which a groove bottom portion is set to a predetermined depth is provided in an outer peripheral surface of the tire annularly along an outer periphery of the tire, and projecting portions for alarm each having an upper surface connecting right and left side walls forming the groove and closing the groove are provided in plural at predetermined intervals along an extending direction of the mark groove at a middle position of the depth between the groove bottom portion and a groove opening portion in the mark groove.

### TECHNICAL FIELD

The present invention relates to a wheel structure of a caster provided in a wheel of a caster, in which a sign groove indicating a tire replacement timing is provided.

### BACKGROUND ART

Conventionally, a caster is widely used as a wheel attached to furniture such as a chair and a bed, a cart and other running bodies.

In this type of caster, a tire is worn by rotation of the wheel, and since a brake shoe is pressed onto an outer peripheral surface of the tire by a biasing force of a spring at braking, the tire is gradually worn and thinned, which leads to a concern that an impact cannot be sufficiently buffered, or a positional relation with the brake shoe is changed and the braking force cannot be sufficiently transmitted.

Then, the caster in Japanese Patent Laid-Open No. 2008-290628, for example, employs such a constitution that, in the caster with a brake device in which a wheel is rotatably and pivotally supported on a lower part of a fork formed having a bifurcated shape, the wheel is formed by a tire part attached to an outer peripheral part of a wheel, and braking is performed by pressing a brake member onto the outer peripheral part of the tire part, a mark member colored in a color different from that of the tire part is embedded inside the tire part of the wheel, and when the outer peripheral part of the tire part is worn by use of the caster, apart of the mark member is exposed to the outer periphery of the tire part.

However, in the aforementioned constitution, the colored mark member needs to be embedded in the tire part, and a skin layer part of the tire needs to be molded with a predetermined thickness on the mark member, which makes the structure complicated and molding difficult.

### CITATION LIST

### Patent Literature

Patent Literature 1: Japanese Patent Laid-Open No. 2008-290628

### DISCLOSURE OF THE INVENTION

### Problem to be Solved by the Invention

This invention is made in view of the aforementioned circumstances and its main problem is to provide a caster structure which can indicate a tire replacement timing by forming a sign groove in an outer peripheral surface of a tire along the outer periphery of the tire without embedding a mark member in the tire so that, when a tire part is worn, the mark groove is gradually faded and is lost in the end.

### Solution to the Problem

The present invention was made in order to solve the aforementioned problem, and the invention in claim 1 is:

a caster structure in which an annular mark groove is provided along an outer peripheral surface of a tire of a wheel in a caster, characterized in that:

the mark groove has a depth from an opening portion of the groove to a groove bottom portion set to a depth which can allow wear of the tire and a plurality of solid projecting portions for alarm each having an upper surface connecting right and left sidewalls forming the groove and closing the groove at a middle position of the depth between the groove bottom portion and the groove opening portion provided at predetermined intervals along an extending direction of the mark groove in the mark groove.

The invention in claim 2 is characterized in that:

the mark groove is formed so as to be gradually narrower from the opening portion of the groove toward a groove bottom surface.

In the invention in claim 3 is characterized in that:

the projecting portions for alarm are disposed in plural at equal intervals along the extending direction of the mark groove.

In the invention in claim 4,

two types or more of projecting portions for alarm with different depth levels are provided between the opening portion of the mark groove and the groove bottom portion, and

an additional projecting portion for alarm with a deeper depth level is disposed between a pair of the projecting portions for alarm with a shallower depth level.

### Advantageous Effects of the Invention

By providing the mark groove, when the surface of the tire is worn by contact with a road surface or a pressure by a brake shoe, the mark groove gradually becomes shallower, and when the upper surface of the projecting portion for alarm comes to the same level as the surface of the tire, the mark grooves which have been in a series are divided by the projecting portions for alarm.

When this mark groove is divided, a user (spectator) can visually recognize wear of the tire to a certain stage and can recognize that a replacement timing of the tire is coming.

Moreover, as the wear of the tire advances, when the groove bottom portion 3 of the mark groove comes to the same level as the surface of the tire, the mark groove is lost, and the user can visually recognize that the replacement timing of the tire has come.

### BRIEF DESCRIPTION OF THE DRAWINGS

FIG. 1 is a perspective view of a caster in which a mark groove in an embodiment 1 is provided.

FIG. 2 is a sectional view of a wheel of the caster.

FIG. 3 is an enlarged view of an “a” part in FIG. 2.

FIG. 4(a) is a partial perspective view of the mark groove before wear, and FIG. 4(b) is a perspective view of a state where an upper surface of a projecting portion for alarm is exposed by the wear and the mark groove is divided.

FIG. 5 is a partial sectional view along a groove extending direction of the mark groove in the embodiment 1.

FIG. 6 is a partial sectional view along the groove extending direction of the mark groove in an embodiment 2.

FIG. 7 is a cross sectional view of the mark groove.

FIG. 8 is a partial sectional view illustrating a mark groove having a different cross-sectional shape.

### DESCRIPTION OF EMBODIMENTS

This invention enables visual recognition of a replacement timing of a tire in stages only by watching an appearance of the tire by forming a mark groove having a projecting portion for alarm in the tire of a caster.

Hereinafter, preferred embodiments of the present invention will be described by referring to the attached drawings.

### Embodiment 1

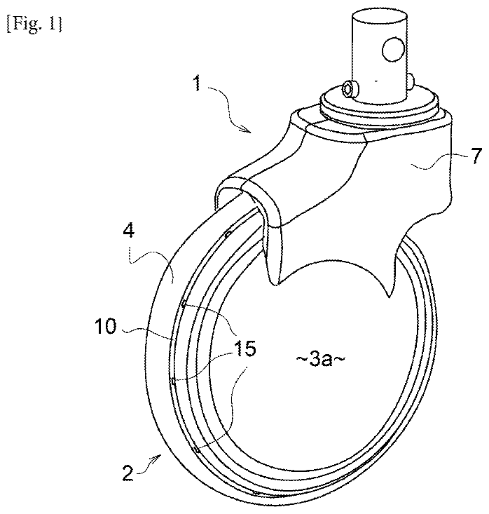

FIG. 1 is a perspective view of a caster 1, and a mark groove 10 having a projecting portion 15 for alarm along an outer periphery of a tire 4 of a wheel 2 is provided therein.

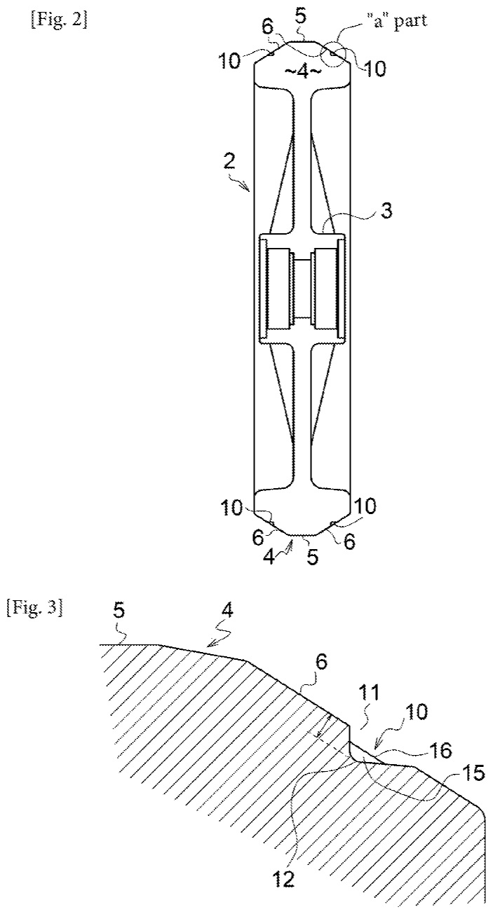

A structure of the caster 1 is not particularly limited in this invention, but in this embodiment, a wheel 3 of the wheel 2 is pivotally supported on a support yoke 7, and the wheel 2 has the tire 4 integrally formed on an outer side of the wheel 3 (see FIG. 2).

Reference character 3a in the figure is a wheel cover.

A well-known brake mechanism or a wheel-braking brake shoe for braking the wheel 2 by friction by being pressed onto an outer peripheral surface of the tire 1 at braking is built in the support yoke 7, though not shown (see a braking structure in Japanese Patent Laid-Open No. 2009-040291, for example).

In the tire 4, the mark groove 10 is formed annularly along the outer periphery thereof.

The outer peripheral surface of the tire 4 may be a flat surface or fan arc surface slightly curved but in this embodiment, as illustrated in FIG. 2, the outer peripheral surface of the tire 4 has a substantially mountain shape constituted by a flat center portion 5 and a shoulder portion 6 which is an inclined surface formed on right and left thereof.

And the mark groove 10 is engraved as an annular groove along the outer periphery of the tire 4 on each of the right and left shoulder portions 6 (see FIG. 1).

The mark groove 10 is for detecting wear of the tire 4 at a spot where the mark groove 10 is disposed, and a groove bottom portion 12 of the mark groove 10 has an arc-shaped section, and a depth of the groove 10 is set in accordance with a wear degree requiring replacement of the tire 4 determined in advance.

In this embodiment, when a diameter of the wheel 2 is 200 mm, the depth of the groove 10, that is, the depth from an opening portion 11 of the groove to the groove bottom portion 12 is set to 1 mm, but the depth of the groove 10 may be set as appropriate in accordance with a material or an application of the tire 4.

The mark groove 10 may be a groove having a cross sectional surface with the same width, but in this embodiment, it is formed into a tapered shape such that right and left side wall surfaces of the groove becomes gradually narrower from the opening portion 11 of the groove to the groove bottom portion 12.

In this embodiment, the mark groove 10 is a groove having a substantially L-shaped cross-sectional surface at approximately 100 degrees and is made of an illustrated sectional shape in which one of the side wall surfaces extends substantially in a vertical direction, while the other extends substantially in a horizontal direction (see FIG. 3).

As described above, by making the side wall surface of the groove 10 a tapered surface at an arbitrary angle, the groove width can be deformed so as to be gradually narrower as the wear of the tire 1 advances and thus, the wear degree can be easily known by the user when seen from outside.

In the aforementioned mark groove 10, projecting portions 15 for alarm are formed in plural at arbitrary intervals along the extending direction of the groove 10.

This projecting portion 15 for alarm has an upper surface 16 continuing to the right and left side wall surfaces of the groove 10 and closing a lower half of the groove formed having a solid block shape substantially in parallel with the opening portion 11 of the groove 10 at a middle position in the depth between the groove bottom portion 12 and the opening portion 11 of the groove or at a position of 0.5 mm which is a half of the groove depth from the surface of the tire 4 in the illustrated example.

A length of the projecting portion 15 for alarm in the groove extending direction is set to approximately 3 mm in the illustrated example, for example, and 12 pieces of them are disposed on an outer periphery of the mark groove 10 at appropriate intervals or at a 30-degree interval, for example (see FIGS. 1 and 5), but the number or interval of the projecting portions 15 for alarm is not particularly limited to the aforementioned numeral values.

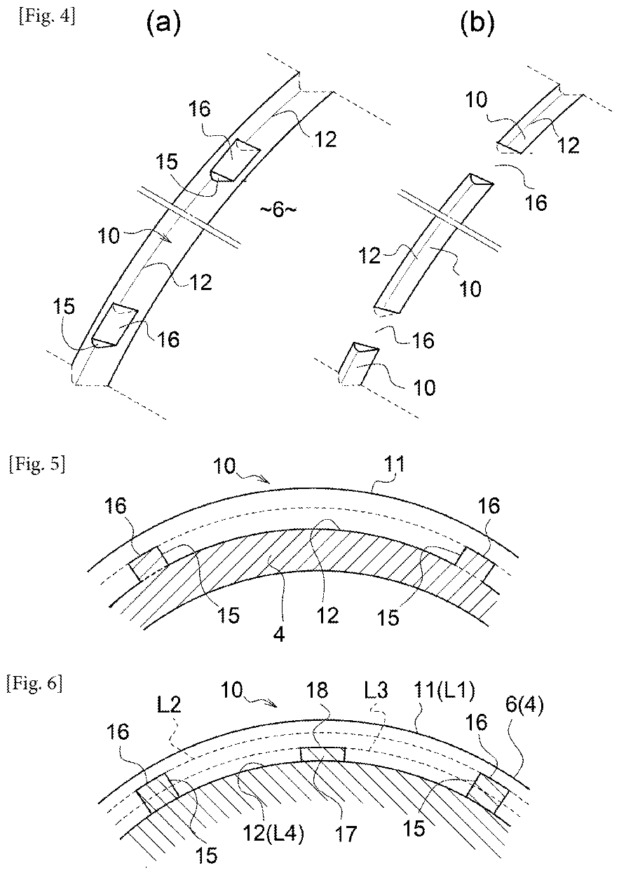

Since the mark groove 10 is made of the aforementioned constitution, from a state before use in FIG. 4(a), the caster 1 is used, and the surface of the tire 4 of the wheel 2 is gradually worn.

The aforementioned wear of the tire 4 may be uniform on the outer peripheral surface in some cases but may be eccentrically worn by a load applied on one side of the outer peripheral surface of the tire 4 in other cases, depending on the work or use conditions.

In this embodiment, the depth of the mark groove 10 gradually becomes smaller by wear on the shoulder portion 6 by an eccentric load or the like.

And when the upper surface 16 of the projecting portion 15 for alarm comes to the same level of the surface of the tire 4(6), as illustrated in FIG. 4(b), a lateral width of the mark groove 10 becomes narrower, the upper surface 16 comes to the same level as the shoulder portion 6 at a spot of the projecting portion 15 for alarm, and the mark groove 10 which has been a series is brought to a state divided by the upper surface 16 of the projecting portion 15 for alarm.

As described above, when the width of the mark groove 10 becomes smaller and is divided, the user can visually recognize that the wear of the tire 4 has advanced to a certain stage from the outside and can know in advance that the replacement timing of the tire 4 is coming.

Then, as the wear of the tire 4 further advances, the groove bottom portion 12 of the mark groove 10 has come to the same level as the surface of the tire 4 (shoulder portion 6), the groove bottom portion 12 is exposed, and the mark groove 10 is lost.

As a result, the user can check visually that the replacement timing of the tire 4 has come.

As described above, in this invention, since the advance state of the wear of the tire 4 can be recognized separately in two stages, the fact that the replacement timing of the tire 4 is coming can be known in advance at the first stage, and components for replacing the tire 4 and others can be prepared in advance for the replacement.

And at the second stage, since the tire 4 can be replaced without delay, a work time loss can be eliminated.

In the aforementioned description, the replacement of the tire 4 is described as an example, but if the tire 4 and the wheel 3 are separable, only the tire 4 can be replaced, but if the tire 4 and the wheel 3 are integrally molded as in the illustrated example, the both are to be replaced.

Moreover, depending on the structure of the caster 1, not only the replacement of them but the entire caster 1 may be replaced.

### Embodiment 2

In the aforementioned embodiment 1, the projecting portion 15 for alarm is provided at the position of approximately a half the depth between the opening portion 11 of the mark groove 10 and the groove bottom portion 12, but two or more projecting portions 15 and 17 for alarm with different depth levels may be provided between the opening portion 11 and the groove bottom portion 12.

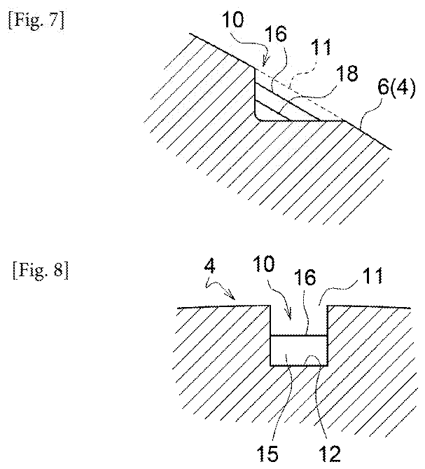

In the mark groove 10 illustrated in FIGS. 6 to 8, the additional projecting portion 17 for alarm is provided at a position deeper than the projecting portion 15 for alarm and shallower than the groove bottom portion 12 between the pair of projecting portions 15 and 15 for alarm separated along the longitudinal direction of the mark groove 10.

In this case, from a level L1 of the opening portion 11 of the mark groove 10, the upper surface 16 of the projecting portion 15 for alarm is exposed at a level L2, and the division interval becomes relatively long by the wear of the tire 4, and further wear causes an upper surface 18 of the additional projecting portion 17 for alarm to be exposed at a level L3, whereby the division interval becomes shorter by the addition of the projecting portion 15 for alarm.

The further wear of the tire 4 is brought to a level L4, and the level is changed to the level L4 at which the groove bottom portion 12 of the mark groove 10 is exposed, the groove 10 is lost, and the groove bottom portion 12 is exposed.

When three or more projecting portions for alarm with different upper surface levels are provided, it may be so configured similarly to the above that the interval between the projecting portions for alarm at a high level is made larger and as the level gets lower, they may be disposed sequentially between the projecting portions for alarm at the higher level.

In the aforementioned embodiment, the wear (eccentric wear) of the shoulder portion 6 is configured to be detected by providing the mark groove 10 in the shoulder portion 6 of the tire 4, but it may be provided in the center portion 5 of the tire 4 so as to detect the wear of the center portion 5.

Moreover, the shape of the tire 4 may be such that the entirety is substantially a flat surface without having the shoulder portion 6.

This mark groove 10 may be disposed at an arbitrary position where the wear is to be detected as long as it is on the outer peripheral surface of the tire, and the number of the groove is not limited to two but may be one or two or more grooves may be provided.

Moreover, the side wall surface of the groove may have a shape extending substantially in parallel to the groove bottom portion as described above (see FIG. 8).

It is needless to say that others, that is, various design changes can be made within a range not changing the gist of this invention.

### REFERENCE SIGNS LIST

1 caster
2 wheel
3 wheel
4 tire
5 center portion
6 shoulder portion
7 support yoke
10 mark groove
11 opening portion of groove
12 groove bottom portion
15 projecting portion for alarm
16 upper surface of projecting portion for alarm
17 additional projecting portion for alarm
18 upper surface of additional projecting portion for alarm

1. A caster structure in which an annular mark groove is provided along an outer peripheral surface of a tire of a wheel in a caster, characterized in that:
the mark groove has a depth from an opening portion of the groove to a groove bottom portion set to a depth which can allow wear of the tire and a plurality of solid projecting portions for alarm each having an upper surface connecting right and left sidewalls forming the groove and closing the groove at a middle position of the depth between the groove bottom portion and the groove opening portion provided at predetermined intervals along an extending direction of the mark groove in the mark groove.

2. The caster structure according to claim 1, wherein
the mark groove is formed so as to be gradually narrower from the opening portion of the groove toward a groove bottom surface.

3. The caster structure according to claim 1, wherein
the projecting portions for alarm are disposed in plural at equal intervals along the extending direction of the mark groove.

4. The caster structure according to claim 1, wherein
two types or more of projecting portions for alarm with different depth levels are provided between the opening portion of the mark groove and the groove bottom portion, and
an additional projecting portion for alarm with a deeper depth level is disposed between a pair of the projecting portions for alarm with a shallower depth level.
